(19) United States
(12) Patent Application Publication
(10) Pub. No.: US 2002/0196874 A1
(43) Pub. Date: Dec. 26, 2002

(54) Gain control apparatus and modem apparatus provided with gain control apparatus

(75) Inventors: Keiichi Tomita, Yokohama-shi (JP); Nobuhiko Noma, Yokohama-shi (JP); Tatsuo Imai, Chigasaki-shi (JP)

Correspondence Address: GREENBLUM & BERNSTEIN, P.L.C., 1941 ROLAND CLARKE PLACE, RESTON, VA, 20191, US

(73) Assignee: MATSUSHITA GRAPHIC COMMUNICATION SYSTEMS INC., Tokyo (JP)

(21) Appl. No.: 10/140,161

(22) Filed: May 8, 2002

(30) Foreign Application Priority Data
Jun. 21, 2001 (JP) JP2001-188227

(51) Int. Cl. H04L 27/06

(52) U.S. Cl. 375/344; 455/234.1

(57) ABSTRACT

A maximum amount searcher searches maximum carrier energy amount, among the energy amounts of multiple carriers that comprise REVERB signals, and a main controller performs a gain control to bring the maximum energy amount to a target gain amount. At the same time, the same gain control for the maximum energy amount is performed for other carrier energy amounts across the board.

### BACKGROUND OF THE INVENTION

1. Field of the Invention

This invention relates to a gain control apparatus that performs a gain control of signal energy attached to each carrier, in communication using multi-carrier method, and a modem apparatus that is provided with the gain control apparatus.

2. Description of Related Art

For communication using xDSL modems including ADSL, communication is performed by adhering to ITU-T standards. Using an ADSL modem, for example, communication is performed by adhering to ITU-T standards, such as G. 992. 1 (G. DMT) and G. 992. 2 (G. Lite). In these standards, DMT (Discrete Multi Tone) method is used for modulating/demodulating by ADSL modems. DMT method is a multi-carrier modulating/demodulating method that employs multiple carriers (sub carriers) with different frequencies.

Signals in communication using xDSL modems can be degraded because of factors such as line conditions. Due to such degradation of signals, signals are undetectable at the receiver side. Therefore, a gain control is used for the degradation of signals, to amplify signal energy.

However, a conventional gain control used in single-carrier communication cannot be applied to an ADSL modem that employs multi-carrier method.

In other words, in single-carrier communication, a gain control is performed by controlling the signal energy of a single carrier so that it will not be amplified to exceed an upper limit of the gain, thereby preventing a overflow. However, for an ADSL modem that handles multi-carrier communication, even if a gain control is performed for one carrier so that its signal energy will not overflow, signal energy of other carriers can overflow. Thus, an appropriate gain control has not been available.

### SUMMARY OF THE INVENTION

The present invention is provided in view of above-described problems. The object of the invention is to provide a gain control apparatus that can appropriately perform a gain control of signal energy in multi-carrier communication, and a modem apparatus that is provided with the gain control apparatus.

In this invention, a maximum carrier energy amount is searched for, among energy amounts of multiple carriers comprising REVERB signals adhering to G. 992. 1 (G. DMT) or G. 992. 2 (G. Lite) of ITU-T standards. A gain control is performed to bring the energy amount to a target energy level, and at the same time, the same gain control for the carrier with the maximum energy amount is also performed for other carrier energy amounts across the board.

Accordingly, it is possible to perform a gain control in case of signal degradation due to factors such as line conditions, and to securely prevent overflows of any carriers. Therefore, it is possible to perform an appropriate gain control that prevents overflows in multi-carrier communication.

### BRIEF DESCRIPTION OF THE DRAWINGS

The present invention is further described in the detailed description which follows, with reference to the noted plurality of drawings by way of non-limiting examples of exemplary embodiments of the present invention, in which like reference numerals represent similar parts throughout the several views of the drawings, and wherein:

FIG. 1 is a block diagram illustrating a configuration of a gain control apparatus according to an embodiment of the present invention;

FIG. 2 is an initial sequence-timing chart based on G. 992. 1 of the ITU-T standard;

FIG. 3 illustrates frequency characteristics of the REVERB signals base on G. 992. 1;

FIG. 4 illustrates frequency characteristics when each carrier energy amount with REVERB signals decreases;

FIG. 5 is a flowchart illustrating a gain control by the gain control apparatus according to the embodiment of the present invention;

FIG. 6(a) is an image when coordinate information (R, I) according to 250 sampling data is stored in a buffer of the gain control apparatus according to the embodiment of the present invention;

FIG. 6(b) is an image for a process to search for a maximum carrier energy amount according to the (R, I) coordination of each sampling data, performed by a maximum amount searcher of the gain control apparatus, according to the embodiment of the present invention;

FIG. 7 is a block diagram illustrating a configuration of integration filter of the gain control apparatus according to the embodiment of the present invention; and

FIG. 8 illustrates a situational example when an ADSL modem that is provided with the gain control apparatus is applied, according to the embodiment of the present invention.

### DETAILED DESCRIPTION OF PREFERRED EMBODIMENTS

The embodiment of the present invention is explained in the following, in reference to the above-described drawings.

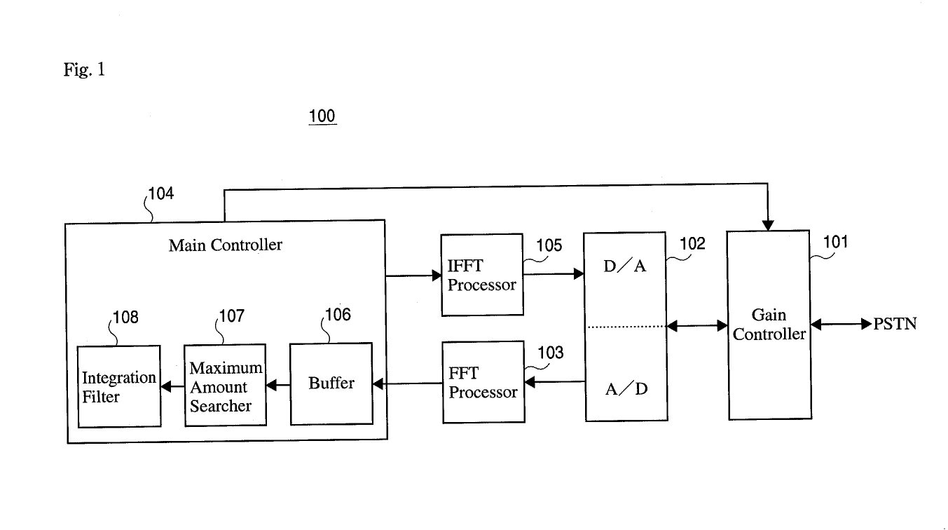

FIG. 1 is a block diagram illustrating a configuration of a gain control apparatus according to the embodiment of the present invention.

In FIG. 1, a gain controller 101 functions as an adjustor for signal energy that is given to each carrier of multi carriers. Specifically, the gain controller 101 performs a gain control for signal energy that is input from a public line (PSTN), via an interface, or output to the PSTN. The gain control by the gain controller 101 is performed according to a gain control amount given by a main controller (later described).

For the gain control apparatus 100, the object is to perform a gain control especially for signal energy that is input from the PSTN, and to appropriately handle input signals. Therefore, the gain controller 101 performs a special gain control upon a signal input. When outputting a signal toward the PSTN, on the other hand, the gain controller 101 performs a general process, e.g., a process for raising energy amount of output signal energy to a predetermined level.

An A/D (D/A) converter 102 performs a digital/analog conversion process (D/A conversion process) of an output signal toward the PSTN, and performs an analog/digital conversion process (A/D conversion process) for an input signal from the PSTN.

The signal after the A/D conversion process by the A/D (D/A) converter 102 is further processed for a Fourier transformation process by the FFT (Fast Fourier Transform) processor 103, and is output to the main controller 104.

An IFFT (Inverse Fast Fourier Transform) processor 105 performs a reverse Fourier transformation process toward the signal that is delivered from the main controller 104, and outputs the signal to the A/D (D/A) converter 102.

The main controller 104 functions as a controller that calculates a gain control amount at the gain controller 101, based on the output from the FFT processor 103 (FFT output).

Specifically, the main controller 104 includes a buffer 106 that stores FFT output, a maximum amount searcher 107 that searches for a maximum amount from the FFT output stored in the buffer 106, and a integration filer 108 that performs a predetermined integral calculation for the maximum amount found by the maximum amount searcher 107, and calculates a gain control amount at the gain controller 101. Details for the calculation of the gain control amount is later described.

The gain control apparatus 100 performs a gain control using the frequency characteristics of the REVERB signals communicated at G. 992. 1 (G. DMT) and G. 992. 2 (G. Lite), which adhere to ITU-T standards.

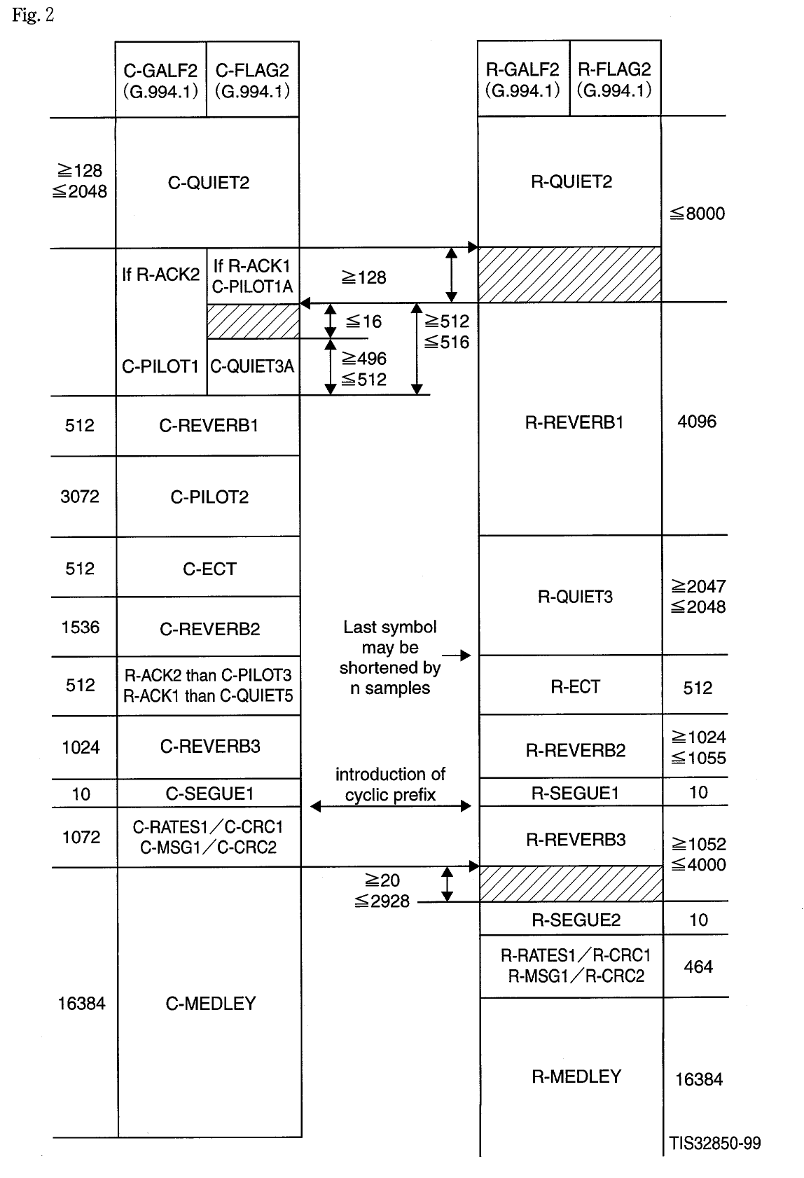

The REVERB signals are used in various situations of standards, such as G. 992. 1. FIG. 2 is an initial sequence-timing chart based on G. 992. 1. In FIG. 2, an ADSL modem of the transmitting side (transmitting station) is on the left, and an ADSL modem of the receiving side (receiving station) is on the right. As shown in FIG. 2, the REVERB signals are transmitted three times (C, R-REVERB1-3) between the transmitting and receiving stations in the initial sequence.

In the G. 992.1 standard, after transmitting the third REVERB signal (C-REVERB3), the transmitting station transmits a SEGUE signal (C-SEGUE1), which indicates that data will follow. The transmitting station, then, transmits C-RATES1 that sets the transmission speed, and C-MSG1 that sets additive information, such as a noise margin. Further, the transmitting station transmits C-MEDLEY that sets transmission speed and data bit numbers, which are attached to each carrier of multi carriers.

Likewise, immediately after the third REVERB signal, transmission of important control signals is performed in the succeeding communication. Therefore, to perform a gain control, it is preferable to complete the gain control before the third REVERB signal. Thus, the gain control apparatus 100 performs a gain control upon receiving the earlier REVERB signals (C-REVERB1, 2), especially the first REVERB signal (C-REVERB1). Accordingly, it is possible to perform a gain control even for REVERB signals appearing after the first REVERB signal (C-REVERB1), which is transmitted/received in the beginning.

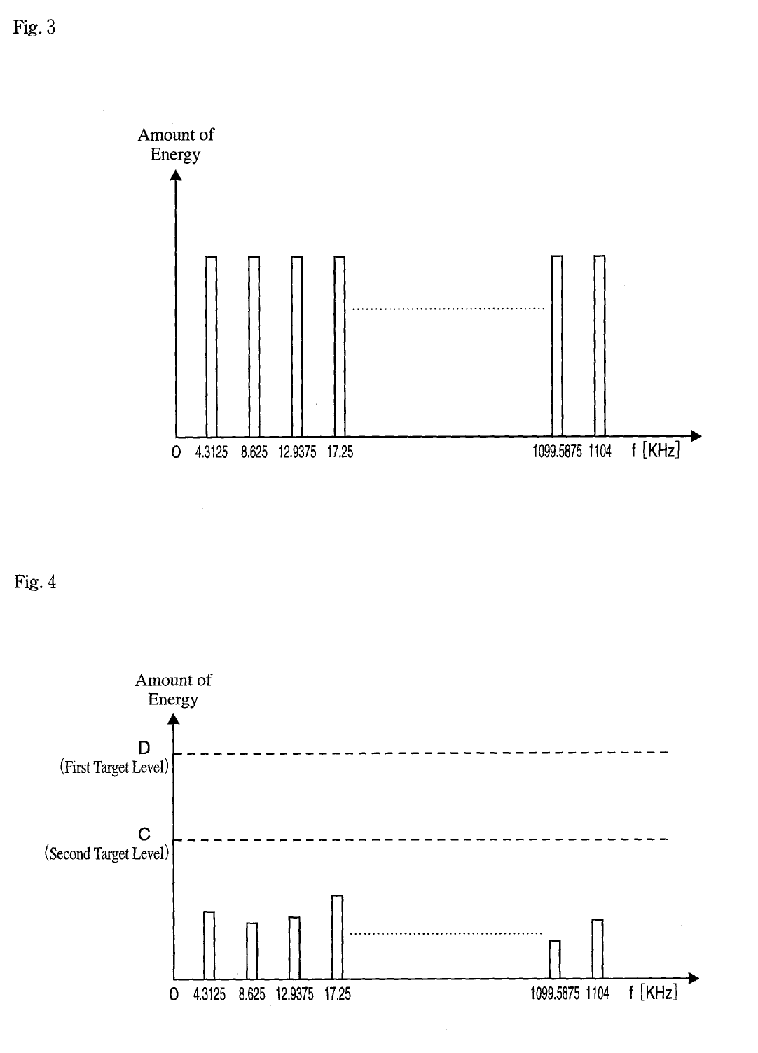

Frequency characteristics of the REVERB signals are explained hereafter. FIG. 3 illustrates frequency characteristics of the REVERB signals. In FIG. 3, lateral axis is frequency (f/kHz) and vertical axis is amount of energy (G/db). FIG. 3 illustrates frequency characteristics when REVERB signals are detected by a detector, such as a spectrum analyzer.

As shown in FIG. 3, each REVERB signal has frequency characteristics with signal energy of the same energy amount, in multiple carriers that are arranged from 1.1104 kHz to 4.3125 kHz period. The carriers are arranged at 4.3125 kHz periods; therefore, the REVERB signals have frequency characteristics that resemble teeth of a comb, as shown in the FIG. 3. The REVERB signals are only comprised of signal energy, and are not attached by data.

The REVERB signals are designed to have such frequency characteristics as shown in FIG. 3, however, in real communication, the energy amounts of the signal energy that is attached to each carrier (carrier energy amounts) could decrease because of line conditions. FIG. 4 illustrates an example of frequency characteristics of REVERB signals when each carrier energy amount decreases. In FIG. 4, the carrier energy amount of 17.25 kHz shows the maximum amount, however, this energy amount is also much lower than the target minimum energy amount (second target level), which is described later.

When the energy amount of each carrier decreases, much lower than the second target level, it is difficult to normally recognize control signals from the transmitting station, even for the following communication, and to normally perform the communication itself. To avoid such problems, the gain control apparatus 100 uses the frequency characteristics of the REVERB signals, and performs appropriate gain controls in multi-carrier communication.

Specifically, the gain control apparatus 100 searches for the maximum carrier energy amount, among energy amounts of multiple carriers comprising REVERB signals, performs a gain control to bring the energy amount to the target energy level, and further performs the same gain control of the maximum carrier energy amount, for other carrier energy amounts across the board. Therefore, it is possible to perform a gain control without overflows, even in multi-carrier communication.

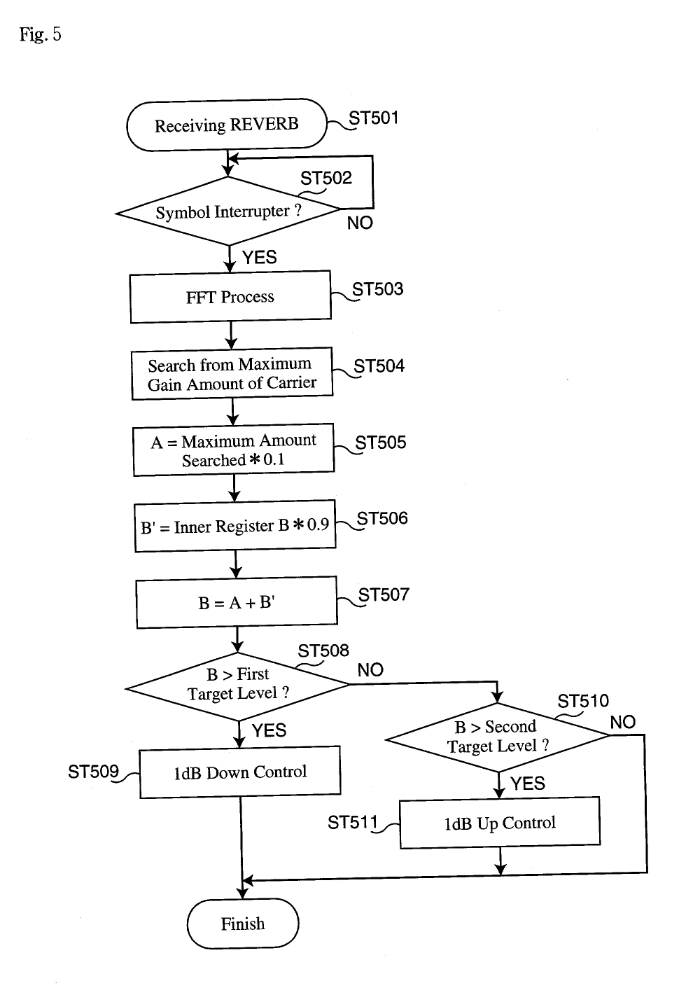

Using FIG. 5, a flow for the gain control apparatus 100 to perform a gain control is illustrated hereafter. FIG. 5 is a flowchart illustrating a gain control by the gain control apparatus 100.

Also, the gain control apparatus 100 always monitors the REVERB signal reception, when it is idle. FIG. 5 shows a flow after confirming the REVERB signal reception, in such a monitoring operation. The REVERB signal reception is confirmed upon detecting an FFT output for receiving a REVERB signal that has the above-described frequency characteristics. That is, the REVERB signal reception is confirmed upon detecting a signal that has the frequency characteristics as shown in FIG. 3.

Upon confirming the reception of a REVERB signal (ST 501), the gain control apparatus 100 waits for a symbol interruption when receiving a REVERB signal (ST 502). When confirming the reception of a REVERB signal, at the gain control apparatus 100, the process of the flow shown in FIG. 5 is repeated.

In the gain control apparatus 100, a symbol interruption is performed approximately every 250. second. Sampling data of input signals, on the other hand, is obtained approximately every 1. second. Each time, an A/D conversion process is performed at the A/D (D/A) converter 102, and data is output to the FFT processor 103. When there is a symbol interruption, an FFT process is performed for this sampling data at the FFT processor 103 (ST 503). Specifically, when sampling data is accumulated for one symbol, an FFT process is performed each time.

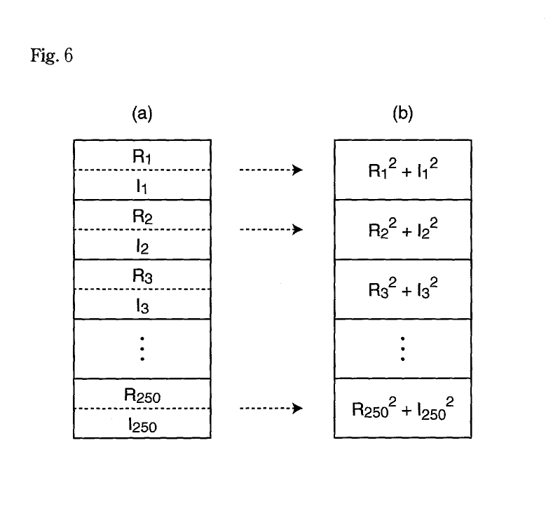

After the FFT process, each sampling data is shown as a coordinate plot on a surface of R-I (Real-Imaginary). Then the coordinate information (R, I) according to each sampling data is stored in the buffer 106. In other words, for each FFT process, the coordinate information (R, I) associated with 250 sampling data is stored. FIG. 6(a) is an image when coordinate information (R, I) according to 250 sampling data is stored in the buffer 106.

When the coordinate information (R, I), according to the sampling data of one symbol, is stored in the buffer 106, the maximum amount searcher 107 searches for the maximum carrier energy amount, among energy amounts of multiple carriers that are comprising the REVERB signals, based on the coordinate information (R, I) (ST 504). The distance of the (R, I) coordinate plot of each sampling data, shown in the R-I surface, from the origin point, amounts to the energy amount of each carrier. Therefore, the maximum amount searcher 107 searches for the maximum carrier energy amount by comparing the distances of the (R, I) coordinate plot of each sampling data from the origin point.

More specifically, maximum carrier energy amount is searched for, by comparing the sum of the squares of each R and I value, on the coordinate plots of each sampling data, which is stored in the 106. FIG. 6(b) is an image for a process to search for a maximum carrier amount according to the (R, I) coordination of each sampling data, performed by the maximum amount searcher 107. Using the example of FIG. 4, 17.25 kHz is found as a maximum carrier energy amount.

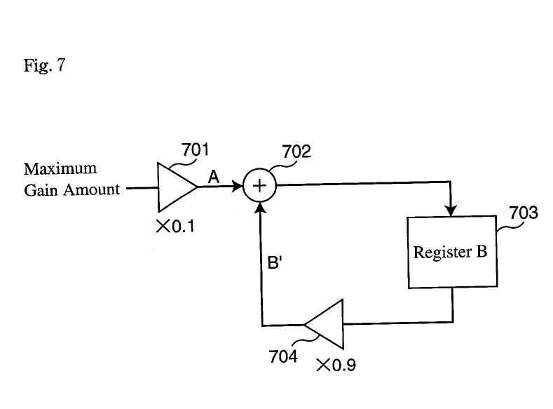

The integration filer 108 performs a predetermined integral calculation for the maximum carrier energy amount, which is found by the maximum amount searcher maximum value searcher 107 (ST 505). FIG. 7 is a block diagram illustrating a configuration of the integration filter 108.

The integration filer 108 outputs value A, to an adder 702, after the maximum carrier energy amount found by the maximum amount searcher 107 is multiplied by 0.1 in a multiplier 701 (ST 505). Also, the integration filer 108 outputs value B′ to the adder 702, after value B stored in an inner register 703 is multiplied by 0.9 in a multiplier 704 (ST 506). Further, the integration filer 108 outputs, to the inner register 703, a sum B (summed by the adder 702) of value A (the input from the multiplier 701); and value B′ (the input from the multiplier 704) (ST 507). This value B is stored in the inner register 703.

Accordingly, by performing the predetermined integral calculation for the maximum carrier energy amount, which is found by the maximum amount searcher 107, it is possible to prevent a large fluctuation of value B by the lower energy amount, even when the maximum carrier energy amount found afterward is decreased suddenly.

When the predetermined integral calculation for the maximum carrier energy amount is completed, the main controller 104 compares value B that is obtained from the integral calculation with the target maximum energy amount (the first target level) and the second target level.

First, the main controller 104 checks whether value B is greater than the first target amount (ST 508). If value B is greater than the first target amount, the main controller 104 controls to decrease the carrier energy amount.

Specifically, the main controller 104 controls the gain controller 101 to decrease the energy amount of the input signal by 1 db (ST 509). According to the control, the gain controller 101 decreases the energy amount of the input signal by 1 db. Then the main controller 104 completes the gain control by the current symbol interruption.

Accordingly, the gain controller 101 decreases all of the carrier energy amounts, which will be input later, by 1 db across the board. Therefore, it is possible to control carrier energy amounts for all the input signals, based on the maximum carrier energy amount that is found by the maximum amount searcher 107.

As described above, when confirming the reception of the REVERB signals, the gain control process of the same flow is repeated. Therefore, when value B is much greater than the first target level, all of the carrier energy amounts of input signals are gradually decreased, so that they are eventually decreased to appropriate amounts that are smaller than the first target level.

When value B is not greater than the first target level, the main controller 104 checks whether value B is smaller than the second target level (ST 510). When value B is smaller than the second target level, the main controller 104 controls to increase the carrier energy amount.

Specifically, the main controller 104 controls the gain controller 101 to increase the energy amount of the input signal by 1 db (ST 511). According to the control, the gain controller 101 increases the energy amount of the input signals by 1 db. Then, the main controller 104 completes the gain control by the current symbol interruption.

Similar to the decreasing control of the energy amount, the gain controller 101 increases all of the carrier energy amounts across the board, which will be input later, by 1 db. Therefore, it is possible to control carrier energy amounts for all the input signals, based on the maximum carrier energy amount that is found by the maximum amount searcher 107.

Also, similar to the decreasing control of the energy amount, when confirming the reception of the REVERB signals, the gain control process of the same flow is repeated. Therefore, when value B is much lower than the second target level, all of the carrier energy amounts of input signals are gradually increased, so that they are eventually increased to appropriate amounts that are greater than the second target level.

Further, at Step 510, when value B is greater than the second target level, the main controller 104 determines that the gain control is not necessary, and terminates the process.

Accordingly, by having a range of target energy level, it is possible to avoid performing a gain control for the maximum energy amount, which is already within the target range. Therefore, it is possible to prevent a complicated process at the apparatus by performing a gain control even for the energy amount that does not need a gain control.

The process of Steps 508-511 is explained in reference to FIG. 4. In the embodiment of the present invention, as shown in FIG. 4, the energy amount for the first target level is “C” and the energy amount of the second target level is “D”. At Step 504, as described above, a carrier energy amount of 17.25 kHz is found as the maximum carrier energy amount. The integral calculation is applied to this maximum amount, and value B is calculated.

Step 508 checks whether the carrier energy amount, 17.25 kHz, is greater than “C”, which is the first target level. As shown in the FIG. 4, the carrier energy amount, 17.25 kHz is smaller than the first target level “C”; therefore, Step 510 checks whether the energy amount is smaller than the second target level “D”. As shown in FIG. 4, the carrier energy amount, 17.25 kHz is smaller than the second target level “D”. Thus, at Step 511, the main controller 104 controls the gain controller 101 to increase the carrier energy amount of the input signal, by 1 db. Under this control, the gain controller 101 increases all of the carrier energy amounts of the input signal by 1 db across the board. When confirming the reception of the REVERB signals, the process of the flow is repeated to increase the energy amount, until the carrier energy amount, 17.25 kHz, becomes greater than the second target level “D”.

According to the gain control apparatus 100 of the present invention, maximum carrier energy amount is searched for among the energy amounts of multiple carriers that comprise REVERB signals, and a gain control is performed to bring the energy amount to a target energy level. At the same time, the same gain control for the maximum energy amount is performed for other carrier energy amounts across the board. Accordingly, it is possible to perform a gain control for signal degradation caused by line conditions and to prevent overflows of any other carriers at the same time. Therefore, it is possible to perform an appropriate gain control that prevents overflows in multi-carrier communication.

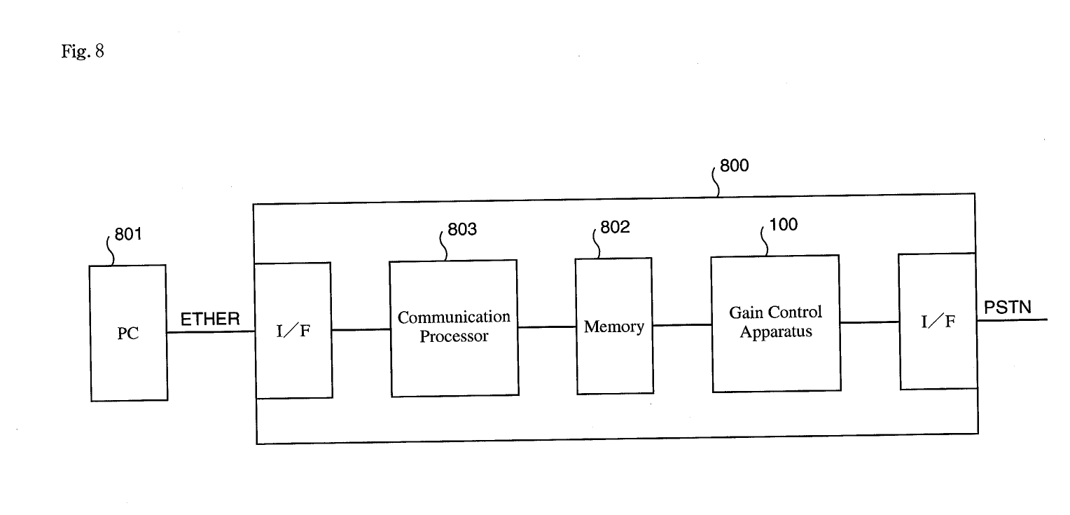

FIG. 8 illustrates a situational example when an ADSL modem 800 that is provided with the gain control apparatus 100, is applied.

As shown in FIG. 8, the ADSL modem 800 that is provided with the gain control apparatus 100, is connected to, for example, a data communication apparatus 801, such as a PC, via a network, such as the Ethernet®, at one end, and to the PSTN at the other end.

The gain control apparatus 100 of the present invention performs a gain control for the signals that are input via the PSTN, as described above. The signals after the gain control process that is performed by the gain control apparatus 100 are stored in a memory 802.

The communication processor 803 retrieves the signals after the gain control, which are stored in the memory 802, controls the communication with an ADSL modem at the other side, and performs a necessary communication process with the data communication apparatus 801 that is connected via the Ethernet®.

Then, the communication processor 803 is able to perform the process in accordance with the signals after the gain control, which is stored in the memory 802. Therefore, it is possible to securely prevent communication errors due to the signal degradation caused by line conditions.

The present invention is not limited to the above-described embodiments, and various variations and modifications may be possible without departing from the scope of the present invention.

This application is based on the Japanese Patent Application No. 2001-188227 filed on Jun. 21, 2001, entire content of which is expressly incorporated by reference herein.

What is claimed is:

1. A modem apparatus for controlling a communication performed with a plurality of carriers, each carrier having a different frequency respectively, the modem apparatus comprising:
an A/D converter that samples a reception analog signal received from a telephone line to output sample data;
a FFT section that performs a fast Fourier transformation process on the sample data by a symbol unit, to obtain a fast Fourier transformation output indicating an energy amount of each carrier configuring the reception analog signal;
a maximum amount detector that detects a maximum energy amount among the Fourier transformation output;
an IFFT section that performs a reverse fast Fourier transformation on transmission data to modulate the transmission data;
a D/A converter that converts the modulated transmission data into transmission analog signal;
a gain controller that performs a gain control on the reception analog signal received from a telephone line before the reception analog signal is input to said A/D converter; and
a main controller that controls said gain controller so that the energy amounts of all the carriers of the reception analog signal increase when the maximum energy amount detected by said maximum amount detector is lower than a predetermined value, and controls said gain controller so that the energy amounts of all the carriers of the reception analog signal decrease when the maximum energy amount detected by said maximum amount detector is higher than the predetermined value.

2. The modem apparatus according to claim 1, the modem apparatus operates in accordance with at least G.992.1 which corresponds to a full-rate ADSL standard, and G.992.2 which corresponds to a half-rate ADSL standard,
wherein said main controller performs the gain control on the reception analog signal and completes the adjustment of the gain control amount of said gain controller while a REVERB signal provided by the ADSL standard is received.

3. The modem apparatus according to claim 1, the modem apparatus carries out in accordance with at least G.992.1 which corresponds to an full-rate ADSL standard, and G.992.2 which corresponds to a half-rate ADSL standard,
wherein said main controller performs the gain control on the reception analog signal and completes the adjustment of the gain control amount of said gain controller while a first REVERB signal is received during an initial sequence provided by the ADSL standard.

4. The modem apparatus according to claim 1, wherein the predetermined value is comprised of a range from a minimum value to a maximum value, said main controller does not control said gain controller to increase or decrease the energy amounts when the detected maximum energy amount is within the range.

5. An ADSL adapter comprising:
a terminal interface connected to an user terminal;
a line interface connected to a telephone line;
a gain control section that performs a multi-carrier demodulation on a reception analog signal, multi-carrier modulation on transmission data and a gain control on a reception analog signal; and
a communication controller that decodes demodulation data performed the multi-carrier demodulation by said gain control section to output to said terminal interface, and encodes the transmission data to output to said gain controller;
wherein said gain control section further comprising:
an A/D converter that samples a reception analog signal received from a telephone line to output sample data;
an FFT section that performs a fast Fourier transformation process on the sample data by a symbol unit, to obtain a fast Fourier transformation output indicating an energy amount of each carrier configuring the reception analog signal;
a maximum amount detector that detects a maximum energy amount among the Fourier transformation output;
an IFFT section that performs a reverse fast Fourier transformation on transmission data to output a multi-carrier modulation signal;
a gain controller that performs a gain control on the reception analog signal received from the telephone line before the reception analog signal is input to said A/D converter; and
a main controller that controls said gain controller so that the energy amount of all the carriers of the reception analog signal increase when the maximum energy amount detected by said maximum amount detector is lower than a predetermined value, and controls said gain controller so that the energy amounts of all the carriers of the reception analog signal decreases when the maximum energy amount detected by said maximum amount detector is higher than the predetermined value.

6. A gain controller for performing a gain control of a reception analog signal during a plurality of carriers, each carrier has a different frequency respectively, the gain controller comprising:
a buffer that stores a fast Fourier transformation output, the fast Fourier transformation output being obtained by performing the fast Fourier transformation on a sample data by a symbol unit, the sample data being obtained by sampling a reception analog signal;
a maximum amount detector that detects a maximum energy amount among the fast Fourier transformation output;
a main controller that increases the energy amounts of all the carriers of the reception analog signal when the maximum energy amount detected by said maximum amount detector is lower than a predetermined value, and decreases the energy amounts of all the carriers of the reception analog signal when the maximum energy amount detected by said maximum amount detector is higher than the predetermined value.

7. A communication control method that performs communication utilizing a plurality of carriers, each carrier having a different frequency respectively, the communication control method comprising:
sampling a reception analog signal received from a telephone line to output sample data;
performing a fast Fourier transformation process on the sample data by a symbol unit, to obtain a fast Fourier transformation output indicating energy amount of each carrier configuring the reception analog signal;
detecting a maximum energy amount among the fast Fourier transformation output;
performing a gain control on the reception analog signal before the sampling;
controlling to increase the energy amounts of all the carriers of the reception analog signal when the detected maximum energy amount is lower than a predetermined value, and controlling to decrease the energy amounts of all the carriers of the reception analog signal when the detected maximum energy amount is higher than the predetermined value.
